(19) United States
(12) Patent Application Publication
(10) Pub. No.: US 2006/0142051 A1
(43) Pub. Date: Jun. 29, 2006

(54) Method and apparatus to optimize the utilization of the carriers in a flexible multi-carrier system

(75) Inventors: Rene Purnadi, Coppell, TX (US); Haihong Zheng, Coppell, TX (US); Naveen Kumar Kakani, Irving, TX (US); Adrian Boariu, Irving, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/025,648

(22) Filed: Dec. 28, 2004

(51) Int. Cl. H04Q 7/20

(52) U.S. Cl. 455/552.1

(57) ABSTRACT

Aspects of this invention provide a MC wireless network, and a method, to allocate at least one carrier to a mobile station. The method includes making an initial carrier allocation of M carrier(s) to the mobile station, where M is less than or equal to a total number of carriers N in the MC wireless network; and subsequently re-allocating carriers to the mobile station, based on at least one criterion, by at least one of changing the value of M and moving the mobile station to at least one different carrier. A mobile station that is operable in the MC wireless network for dynamically changing its carrier allocations is also provided.

### TECHNICAL FIELD

The presently preferred embodiments of this invention relate generally to wireless communications systems and, more specifically, relate to radio frequency (RF) communications systems employing a plurality of RF carriers (a multi-carrier system) such as, but not limited to, a proposed multi-carrier code division multiple access (CDMA) system that is currently known generally as cdma2000 3X EV-DV, also referred to as cdma2000 Multi-Carrier (MC), and variations thereof.

### BACKGROUND

As currently specified, the cdma2000 MC system evenly distributes downlink traffic (traffic from a base station (BS) to a mobile station (MS)) to all of the forward link carriers (to the three specified 1.25 MHz carriers).

Some wireless communications systems, such as the cdma2000 system, have evolved from one carrier to multiple carriers in order to increase the available bandwidth. As was noted, in the current cdma2000 MC (three carrier) standard the downlink data is evenly distributed in all three carriers. However, the equal allocation of downlink data across the multi-carriers may not always represent the most optimum utilization of these carriers, and may not optimize the conservation of battery power in the MS.

As presently specified, the current cdma2000 MC standard also does not allow the MS to be re-assigned from one carrier to another carrier due to changes in certain parameters, such as the load condition of the carrier, or to add or reduce a carrier or carriers in the event a certain parameter, such as a downlink data buffer, exceeds a threshold (either a lower or an upper threshold).

The inventors are not aware of any proposed or implemented techniques to achieve carrier re-assignment or carrier modification in existing multi-carrier systems, such as the cdma2000 MC system. Instead, as presently specified in the cdma2000 MC system the MS is either assigned one carrier or three carriers during call setup, and there is no capability to then subsequently change a carrier or to add or reduce the number of carriers during a session, or even after a session has ended.

### SUMMARY OF THE PREFERRED EMBODIMENTS

The foregoing and other problems are overcome, and other advantages are realized, in accordance with the presently preferred embodiments of this invention.

In one aspect thereof this invention provides a MC wireless network with a method to allocate at least one carrier to a mobile station. The method includes making an initial carrier allocation of M carrier(s) to the mobile station, where M is less than or equal to a total number of carriers N in the MC wireless network; and subsequently reallocating carriers to the mobile station by moving the mobile station to different carrier(s) and/or by changing the value of M based on at least one criterion.

In another aspect thereof this invention provides a MC wireless network that includes a carrier selector function operable to make an initial carrier allocation of M carrier(s) to a mobile station, where M is less than or equal to a total number of carriers N in the MC wireless network; and that is further operable to re-allocate carriers to the mobile station by moving the mobile station to different carrier(s) and/or by changing the value of M based on at least one criterion.

In a still further aspect thereof this invention provides a mobile station operable in a MC wireless network, where the mobile station includes a transceiver and a controller, where the controller is responsive to a first message received from the MC wireless network via the transceiver to establish an initial carrier allocation of M carrier(s) for communication with the MC wireless network, where M is less than or equal to a total number of carriers N in the MC wireless network, and where the controller is further responsive to a subsequent message received during one of a circuit switched or a packet switched communication from the MC wireless network via the transceiver to re-allocate the mobile station to different carrier(s) and/or to change a number of carriers for communication with the MC wireless network.

In another aspect thereof this invention provides a computer program product embodied on a computer readable medium. The computer program product comprises program instructions for directing at least one computer that comprises part of a MC wireless network to perform operations to allocate at least one carrier to a mobile station. The operations comprise making an initial carrier allocation of M carrier(s) to the mobile station, where M is less than or equal to a total number of carriers N in the MC wireless network, and subsequently re-allocating carriers to the mobile station, based on at least one criterion, by at least one of changing the value of M and moving the mobile station to at least one different carrier.

In another aspect thereof this invention provides a computer program product embodied on a computer readable medium. The computer program product comprises program instructions for directing at least one computer that comprises part of a mobile station to perform operations in a MC wireless network. The operations comprise, responsive to a first message received from the MC wireless network via a transceiver, establishing an initial carrier allocation of M carrier(s) for communication with the MC wireless network, where M is less than or equal to a total number of carriers N in the MC wireless network and further responsive to a subsequent message received during one of a circuit switched or a packet switched communication from the MC wireless network via the transceiver, re-allocating at least a number of carriers for communication with the MC wireless network.

In a further aspect thereof this invention provides a MC wireless network that comprises means for initially selecting carriers to make a carrier allocation of M carrier(s) to a mobile station, where M is less than or equal to a total number of carriers N in the MC wireless network; and further comprising means, responsive to at least one criterion, for re-allocating carriers to the mobile station by at least one of changing the value of M and moving the mobile station to at least one different carrier.

In a still further aspect thereof this invention provides a mobile station operable in a MC wireless network. The mobile station comprises transceiver means and control means. The control means is responsive to a first message received from the MC wireless network via the transceiver means to establish an initial carrier allocation of M carrier(s) for communication with the MC wireless network, where M is less than or equal to a total number of carriers N in the MC wireless network. The control means is further responsive to a subsequent message received during one of a circuit switched or a packet switched communication from the MC wireless network via the transceiver means to re-allocate at least a number of carriers for communication with the MC wireless network.

### BRIEF DESCRIPTION OF THE DRAWINGS

The foregoing and other aspects of the embodiments of this invention are made more evident in the following Detailed Description of the Preferred Embodiments, when read in conjunction with the attached Drawing Figures, wherein:

FIG. 1 is a block diagram of an example of a radio layer protocol stack of a multi-carrier wireless network, in accordance with one non-limiting embodiment of this invention, where in one aspect thereof a RMF (Resource Management Function) in a MAC Layer instructs a MS through upper layer signaling for CS (Circuit Switch) operation and through a FPDChCF for PS (Packet Switch) operation;

FIG. 2 is a block diagram of a radio layer protocol stack of a multi-carrier wireless network, in accordance with another non-limiting embodiment of this invention, where in one aspect thereof a RMF in the PHY Layer instructs the MS through upper layer signaling for CS operation and through a FPDChCF for PS operation;

FIG. 3 is a block diagram of the resource management function that forms a part of the carrier selector function shown in FIGS. 1 and 2;

FIG. 4 is a logic flow diagram of a Carrier Assignment algorithm for a three carrier user Mode 1); and

FIG. 5 is a logic flow diagram of a Carrier Assignment algorithm for a three carrier user (Mode 2).

### DETAILED DESCRIPTION OF THE PREFERRED EMBODIMENTS

Aspects of the embodiments of the invention described below relate to methods and apparatus to assign and modify the active carriers in a multi-carrier communications system.

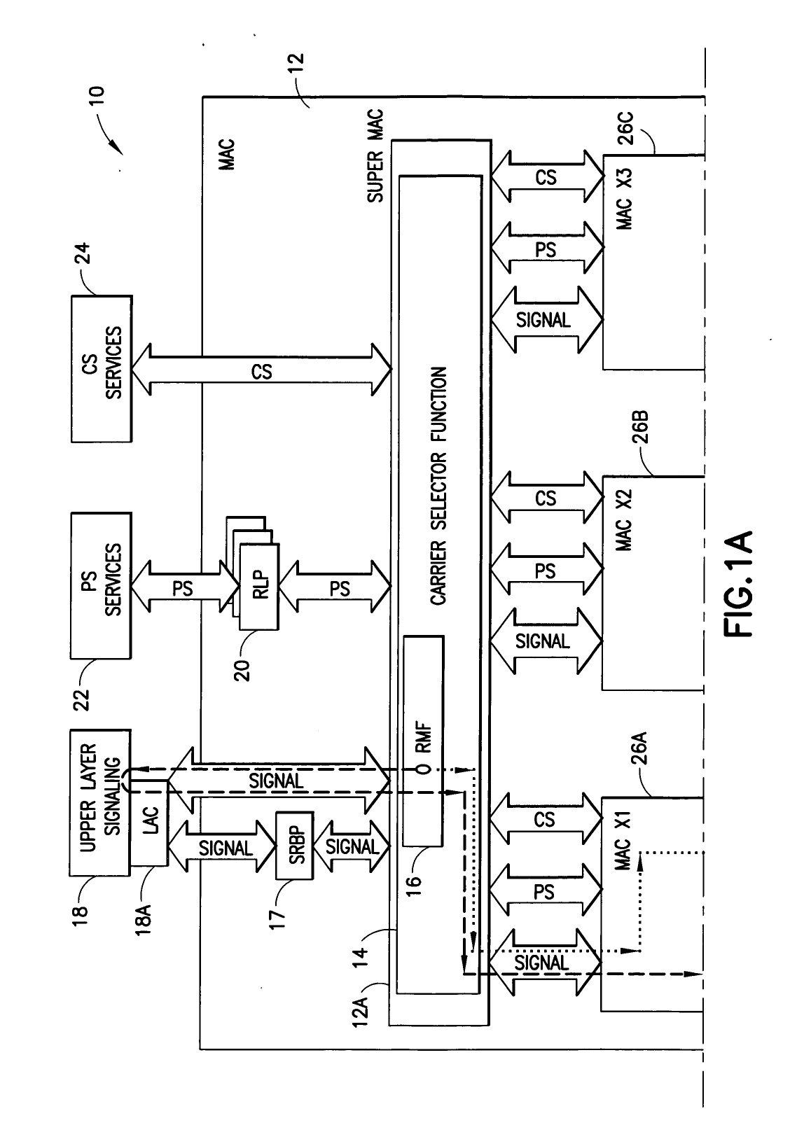

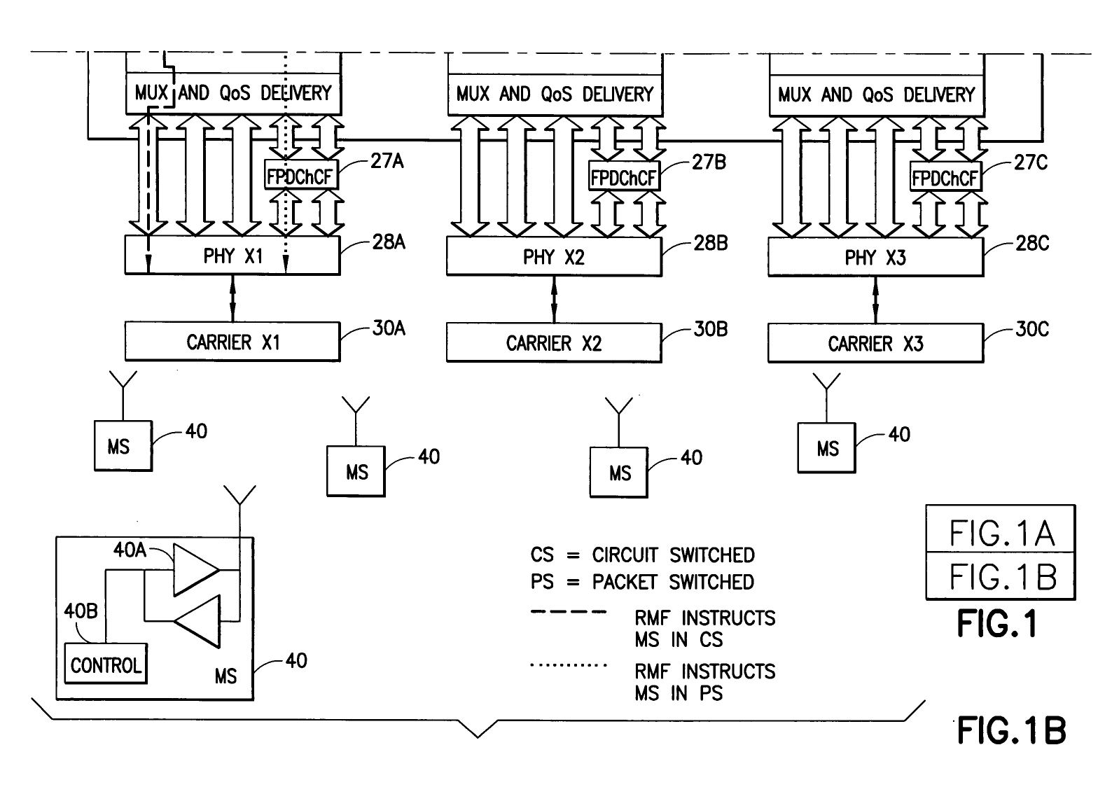

FIG. 1 is a block diagram of an example of a radio layer protocol stack 10 that is associated a MC wireless system or network, that is constructed and operated in accordance with the preferred embodiments of this invention. A Medium Access Control (MAC) layer 12 includes a carrier selector function (CSF) 14 that includes a Resource Management Function (RMF) 16 that operates in accordance with the embodiments of this invention. An upper layer signaling block 18 is directly coupled to the MAC 12, or is indirectly coupled via a SRBP (Signaling Radio Burst Protocol) block 17 and with a LAC (Link Access Control) 18A. Also coupled to the MAC 12 via a plurality of Radio Link Protocol (RLP) blocks 20 is a Packet Switched (PS) services function 22. Also coupled to the MAC 12 is a Circuit Switched (CS) services function 24. Each of the three carriers has an associated MAC function (X1, X2, X3) 26A, 26B and 26C each having an associated multiplexing (MUX) and Quality of Service (QoS) functionality, and each MAC function 26A, 26B, 26C has associated signaling, PS and CS inputs and outputs that are interfaced to the upper layer signaling function, 18, the PS service 22 and the CS services 24 via the intervening carrier selector function 14. Each MAC function 26A, 26B, 26C is associated with a corresponding physical (PHY) layer (X1, X2, X3) 28A, 28B and 28C, and with one of the three carriers (X1, X2, X3) 30A, 30B, 30C, collectively referred to as carriers 30, of the MC radio layer protocol stack 110. Each of the carriers 30 can convey a plurality of radio channels. The signaling portion of the interface between MACs 26A, 26B, 26C and the PHYs 28A, 28B, 28C is conveyed through a Forward Packet Data Control Channel (FPDCCH) that includes a Forward Packet Data Channel Control Function (FPDChCF), designated as 27A, 27B and 27C.

Also shown in FIG. 1 are a plurality of mobile stations (MS) 40 that are bidirectionally coupled to the carriers 30A, 30B, 30C for receiving packet switched and/or circuit switched services. The various MS 40 can include, but are not limited to, cellular telephones, personal digital assistants (PDAs), portable computers, image capture devices such as digital cameras, gaming devices, music storage and playback appliances, Internet appliances permitting Internet access and browsing, as well as portable units or terminals that incorporate combinations of such functions. Each MS 40 is assumed to include at least a wireless transceiver 40A that is MC compatible, and a controller 40B operable to receive and respond to messages from the protocol stack 10 of the MC wireless network, in accordance with the embodiments of this invention. The transceiver 40A may be a radio frequency (RF) transceiver or an optical transceiver (e.g., and IR transceiver), depending on the nature of the multi-carrier system of interest.

The presently preferred MC technique optimizes the use of the carriers 30 by dynamically assigning downlink traffic to one or more of the carriers 30. Certain system parameters, such as load condition and the radio condition in a carrier, a user buffer 42 (see FIG. 3) condition (e.g., empty, full, nearly empty, nearly full, half full, etc.), and updated QoS requirements, may trigger the RMF 16 in the protocol stack 10 to modify the assigned carriers 30 by moving a particular user's MS 40 to another carrier, and/or to add or eliminate carrier(s) being used by a particular MS 40.

In one non-limiting and presently preferred embodiment of this invention the MS 40 can be setup to use one or more carriers 30 when receiving data, depending on the required QoS. Typically, more stringent QoS requirements (e.g., higher throughput, lower delay, etc.) will result in more than one of the carriers 30 being assigned to the MS 40. Various non-limiting QoS requirements that may be monitored by the RMF 16 include bandwidth, delay and loss rate. For example, a CS voice call may be serviced by one carrier, while a video streaming service may be serviced by two or three carriers.

At least a portion of the protocol stack 10 of the MC wireless network monitors certain system parameters. As non-limiting examples the protocol stack 10, in particular the RMF 16, monitors the load condition and the radio condition in each of the carriers 30, the level or state of buffers 42 associated with the various MSs 40, and an occurrence of updated and revised QoS requirements. For example, an occurrence of an unbalanced load condition between individual ones of the carriers 30, and/or a bad radio condition in a particular one of the carriers 30, triggers the RMF 16 to re-assign a MC-capable one of the MSs 40 to other carrier(s) 30. For example, a MS 40 network buffer 42 that exceeds an upper/lower threshold, or an occurrence of an updated QoS parameter, is capable of triggering the RMF 16 not only to add or eliminate (supplemental) channel(s) within one of the carriers 30, but also to add or eliminate radio channel(s) in different carrier(s) 30, if desired.

As was stated, in the presently preferred embodiments of this invention the RMF 16 monitors certain MC wireless system parameters. Once the RMF 16 detects a need to re-assign and/or to modify the carrier assignment, the RMF 16 sends a carrier modification indication, for a packet switched session, to the FPDChCF 27 in a current (source) carrier over the FPDCCH. For a circuit switched session the RMF 16 instead sends the carrier modification indication to Layer 3 (L3), part of upper layer signaling block 18, to directly send a L3 message either through the f-dsch (forward dedicated signaling channel), or multiplexed in a fundamental f-dtch (forward dedicated traffic channel), to signal the MS to move to other carrier(s) 30, and/or to add or to eliminate carrier(s) 30. The message from the RMF 16 to the FPDChCF 27 contains parameters that are interpreted by the FPDChCF 27 and forwarded to the MS 40. The message from the RMF 16 to the L3 contains parameters interpreted by L3, part of upper layer signaling 18, and forwarded to the MS 40.

If each one of the carriers 30 has an independent FPDChCF 27, as shown in the embodiment of FIG. 1, the RMF 16 also sends a (second) message to the FPDChCF in the destination (target) carrier(s) 30 to instruct the target FPDChCF 27 to prepare the appropriate radio resources in the target carrier. If the multiple carriers 30 are instead controlled by a single FPDChCF 27, the same FPDChCF 27 prepares the appropriate radio resources in the target carrier(s) 30, and the use of the subsequent message may not be required.

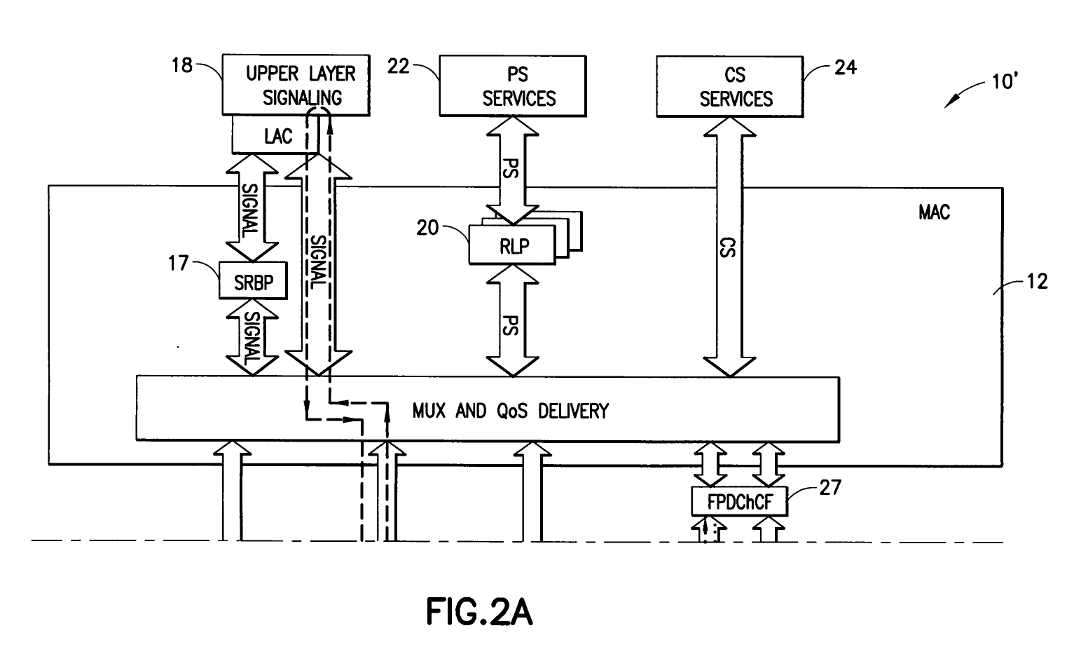

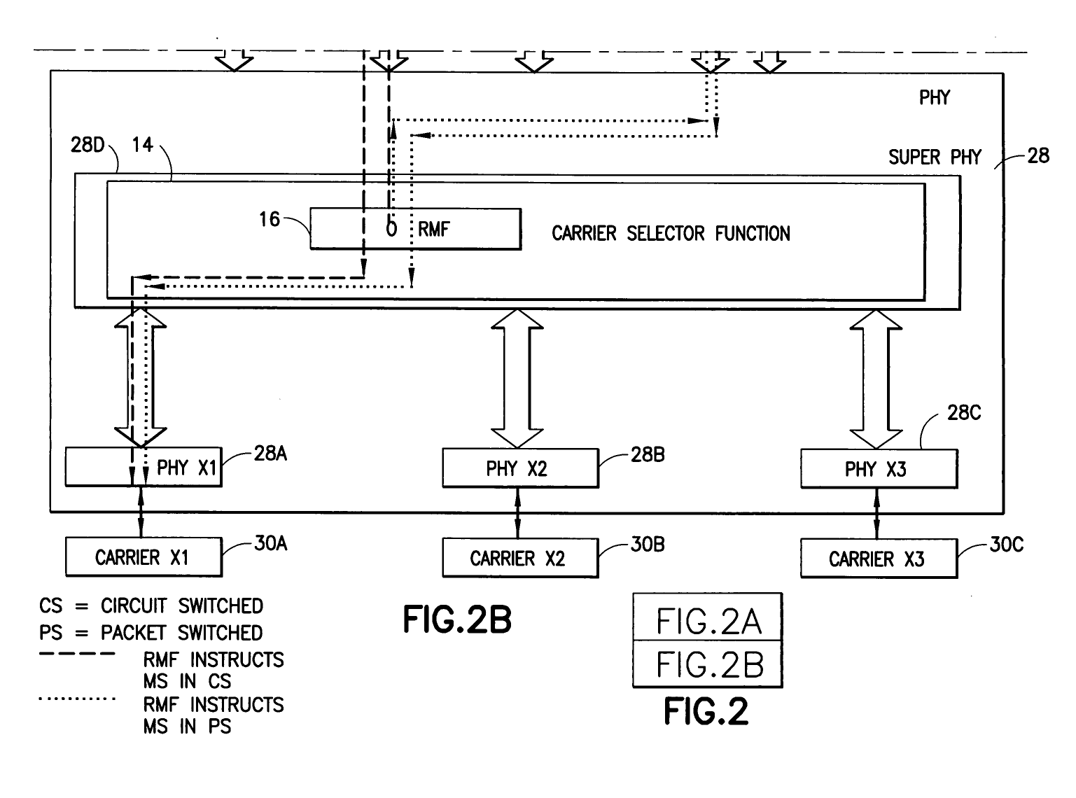

There are two presently preferred embodiments for implementing this invention. The first embodiment is based on the carrier selector function 14 in the cdma2000 MAC layer 12, as shown in FIG. 1, while the second embodiment is based on placing the carrier selector function 14 in the physical layer 28, and is shown in FIG. 2 and discussed further below.

In the first embodiment, and as was already at least partially discussed, the RMF 16 is located in MAC layer 12, adjacent to the carrier selector function 14. The lower (sub)layer(s) 26, 28 continuously send carrier-related information, for example the load conditions in each of the carriers 30, the radio conditions in each of the carriers 30, and the MAC PDU (Packet Data Unit) buffer 42 of each QoS category for a user, to the RMF 16. The upper layer 18 may also send, for example, modified or updated QoS information to the RMF 16 (note that the layers 22 and 24 contain payload, and not signaling per se). The receipt of this information may trigger the RMF 16 to move a particular MS 40 to a different carrier(s), and/or to add or to eliminate one or multiple carriers 30. The RMF 16 instructs the MS 40 to use different carriers, and/or to add or to eliminate one or multiple carriers 30 through the upper layer (L3) signaling entity for a CS session or through the FPDChCF 27 for a PS session, as shown in FIG. 1. As was noted above, the upper layer signaling entity sends the instruction through f-dsch or multiplexed in the fundamental f-dtch to the MS 40, while the FPDChCF 27 sends the instruction through the F-PDCCH to the MS 40.

The RMF 16 may also indicate to the upper layer signaling entity and/or the target FPDChCF 27 to instruct the (target) carrier(s) to prepare or release resources for the MS 40.

Referring to FIG. 2, in another embodiment of the MC radio layer protocol stack 10′ the RMF 16 is located in PHY layer 28, adjacent to the carrier selector function 14 that is also located in PHY. As in the embodiment of FIG. 1, the lower (sub)layer(s) 28 continuously send carrier-related information, for example the load conditions in each of the carriers 30, the radio conditions in each of the carriers 30, and the radio frame buffer 42′ for a user, to the RMF 16. It may be noted that in this embodiment the buffer is the radio frame buffer, which does not recognize the QoS Category since the scheduling is performed in the MAC 12. The upper layer 18 may also send, for example, modified or updated QoS information to the RMF 16. The receipt of this information may trigger the RMF 16 to move a particular MS 40 to a different carrier(s), and/or to add or to eliminate one or multiple carriers 30. The RMF 16 instructs the MS 40 to use different carriers, and/or to add or to eliminate one or multiple carriers 30 through the upper layer (L3) signaling entity for a CS session or through the (single instance in this case) FPDChCF 27 for a PS session, as shown in FIG. 2. As was noted previously, the upper layer signaling entity sends the instruction through f-dsch or multiplexed in the fundamental f-dtch to the MS 40, while the FPDChCF 27 sends the instruction through the F-PDCCH to the MS 40. As in the embodiment of FIG. 1, the RMF 16 may also indicate to the upper layer signaling entity and/or the target FPDChCF 27 to instruct the (target) carrier(s) to prepare or release resources for the MS 40. In the presently preferred, but non-limiting embodiments of this invention there is one FPDChCF 27 per carrier.

As examples, the embodiments of this invention may be implemented through the use of a modification to the L3 signaling (e.g., in an Extended Channel Assignment Message) and in the PDCCH (e.g., in a PHY-DecodeFPDCCH message) to carry the carrier change-related instruction to the MS 40.

Advantages that can be realized through the use of the embodiments of this invention are several. For example, the RMF 16 allows the protocol stack 10 of the MC wireless network to optimize the delivery of the forward link traffic by changing, adding or eliminating one or more carriers dynamically during a session. The RMF 16 may also use a currently available mechanism to deliver the instruction to the MS 40 for both CS (through the upper layer signaling entity) and PS (through the FPDChCF 27) sessions.

Referring also to FIG. 3, the use of the embodiments of this invention provide a capability to assign, re-assign and add or eliminate a carrier or carriers used by an active MS 40, based on certain parameters such as, but not limited to, the load condition in each carrier, the radio condition in each carrier, the state of user buffers 42, and revised QoS information received from upper and/or lower layers. New primitives may be used between the resource management function 16 to the upper layer signaling entities 18 and the F-PDChCF 27, as well as modified messages from the upper layer signaling entity or entities 18 to the MS 40, as well as from the FPDChCF 27 to the MS 40. These new primitives and modified message formats are preferably employed to instruct the MS 40 to move to a different carrier and/or to add or to eliminate a carrier(s).

The preferred embodiments of this invention enable the forward link transmission of user data over M sub-carriers in an N sub-carrier system, where M≦N. Without restricting the generality, N=3 and the network can be referred to as a 3x network or system. For example, in the cdma2000 MC system the user data can be transmitted over one, two or three sub-carrier(s) 30, as opposed to being evenly spread over all three sub-carriers 30. The entity that determines the number of sub-carrier(s) and which sub-carrier(s) to be used is termed the carrier selector function (CSF) 14, and it contains as an element thereof the RMF 16.

With the carrier selector function 14 in the MAC layer 12, as shown in FIG. 1, each 1x sub-carrier is served by an individual PHY function. Each PHY corresponds to one MAC Xi that contains the multiplexing and QoS delivery function, for that particular 1x sub-carrier. A SuperMAC function 12A (that primarily implements the carrier selector function) can be located directly above the MAC Xi. For each data unit passed to MAC layer 12, termed as MAC SDU, SuperMAC 12A, using the RMF 16, selects one, two or three sub-carrier(s) to carry the traffic for an enabled 3x mobile user (MS 40). The MAC SDU is then passed to the corresponding MAC Xi 26 and then to the PHY Xi 28. Note that this embodiment permits the independent scheduling of data transmission for each individual 1x sub-carrier.

In the second embodiment of FIG. 2 the carrier selector function 14 is implemented in the PHY layer 28, and each carrier is served by one PHY Xi function 28A, 28B, 28C. Each PHY Xi function implements all the physical layer functions defined in the conventional single carrier system. A SuperPHY 28D (that primarily implements the carrier selector function 14) is located above PHY Xi. The PHY layer 28 interfaces with the MAC layer 12 through the SuperPHY 28D. For each data unit passed to MAC layer 12, the MAC SDU, the MAC 12 performs the MAC functions, generates the physical layer SDU and passes it to the SuperPHY function 28D. The carrier selector function 14, more particularly the RMF 16, in the SuperPHY 28D selects one, two or three sub-carrier(s) to transmit the traffic. The PHY SDU is then passed to the corresponding the PHY Xi 28A, 28B, 28C for transmission. Note that this embodiment allows not only the independent scheduling of data transmission for each individual 1x sub-carrier, but also allows joint scheduling of data transmission over more than one 1x sub-carrier.

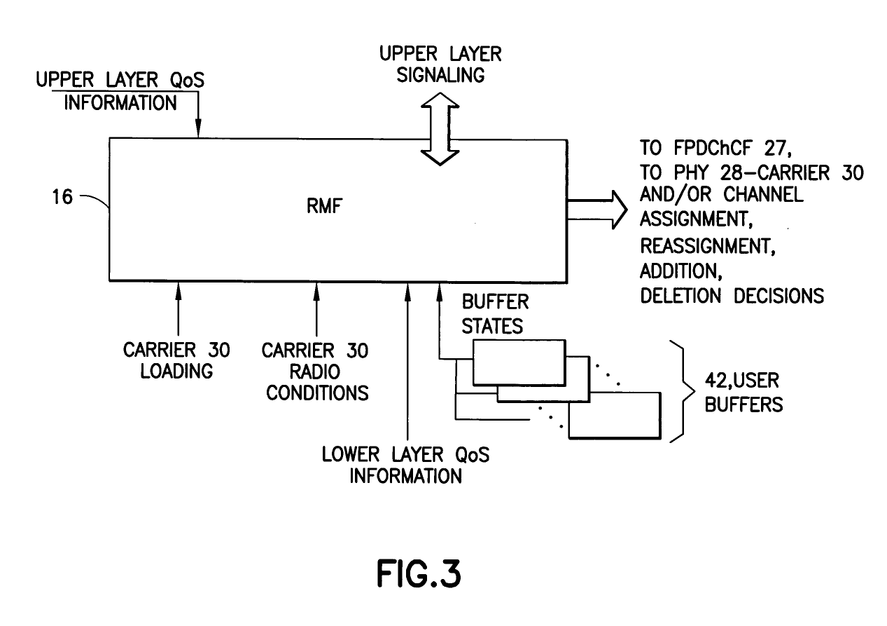

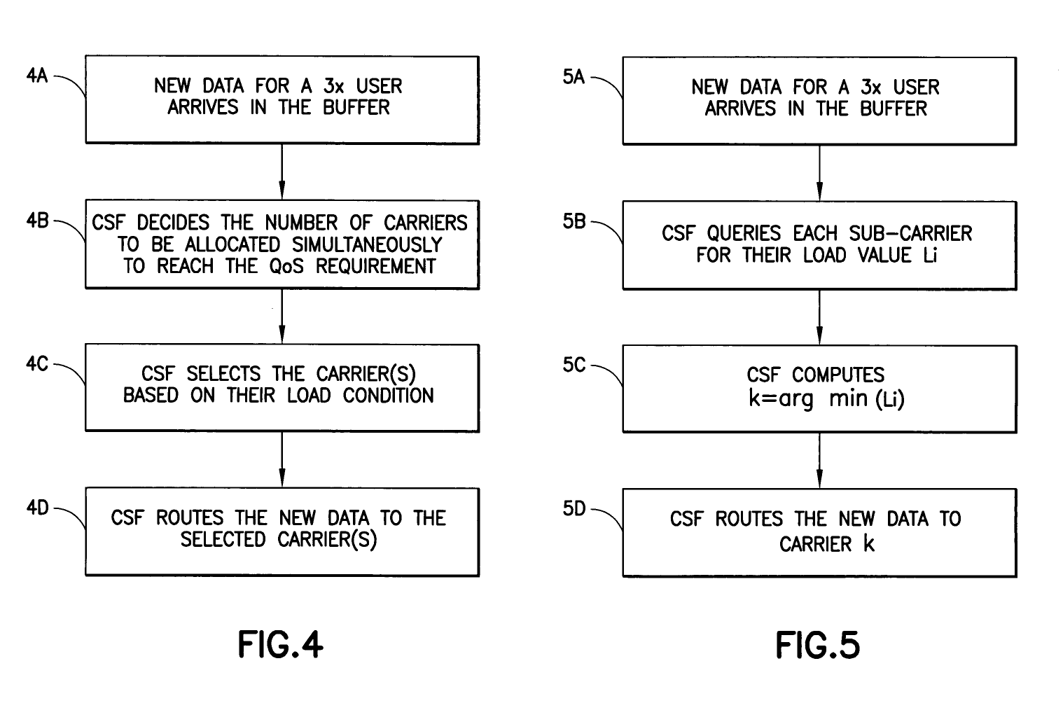

Regardless of the location of carrier selector function 14 and the RMF 16, a common carrier selection algorithm can be applied. The following examples shown in FIGS. 4 and 5 illustrate how the carrier(s) 30 are selected for 3x user MSs 40. Note that just the load condition is used as an example criteria for the RMF 16 to select the carrier(s) 30, although other criteria could be used as well, as was discussed above. In FIGS. 4 and 5 CSF stands for the carrier selector function 14.

In a first mode of operation, shown in FIG. 4, when a 3x user requests resources the carrier selector function 14 directly assigns the number of carrier(s) 30 required to carry the data based on at least some certain QoS requirement of the user traffic and carrier load condition. When new data arrives for the 3x MS 40 in the appropriate buffer 42 (block 4A) the carrier selector function 14 determines the number of carriers 30 that need to be allocated simultaneously to fulfill the QoS requirement (block 4B), then selects the carrier or carriers based on current carrier load conditions (block 4C), and then routes the new data to the selected carrier or carriers 30 (block 4D).

In a second mode of operation, shown in FIG. 5, the carrier selector function 14 allocates one sub-carrier at a time, and may subsequently select a different carrier based on one or more parameters, such as load condition and/or a change in QoS requirements. When new data arrives for the 3x MS 40 in the appropriate buffer 42 (block 5A) the carrier selector function 14 queries at block 5B each sub-carrier, via the PHY Xi 28, for their respective load value (Li). At block 5C the carrier selector computes a value for k, i.e., it determines the sub-carrier having the minimum loading factor, and at block 5D the carrier selector function 14 routes the new data from the appropriate buffer 42 to the carrier k (block 5D). Based on the foregoing description it should be appreciated that a further aspect of this invention is the MS 40 operable in the MC wireless network. The MS 40 includes the transceiver 40A and the controller 40B that is responsive to a first message received from the MC wireless network via the transceiver 40A to establish an initial carrier allocation of M carrier(s) for communication with the MC wireless network, where M is less than or equal to a total number of carriers N in the MC wireless network. The controller 40B is further responsive to a subsequent message received during one of a circuit switched (CS) or a packet switched (PS) session or communication from the MC wireless network via the transceiver 40A to re-allocate at least a number of carriers for communication with the MC wireless network. In a non-limiting embodiment, and for the packet switched case, the MS 40 receives the subsequent message via at least one FPDChCF 27 through a FPDCCH. In another non-limiting embodiment, and for the circuit switched case, the MS 40 receives the subsequent message through the forward dedicated signaling channel (f-dsch), or multiplexed in the fundamental forward dedicated traffic channel (f-dtch) from upper layer signaling 18.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent messaging formats and/or upper and/or lower layer signaling mechanisms may be attempted by those skilled in the art. However, all such and similar modifications of the teachings of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

What is claimed is:

1. In a multi-carrier (MC) wireless network, a method to allocate at least one carrier to a mobile station, comprising:
making an initial carrier allocation of M carrier(s) to the mobile station, where M is less than or equal to a total number of carriers N in the MC wireless network; and
subsequently re-allocating carriers to the mobile station, based on at least one criterion, by at least one of changing the value of M and moving the mobile station to at least one different carrier.

2. A method as in claim 1, where the at least one criterion is comprised of a change in a quality of service (QoS) requirement of the mobile station.

3. A method as in claim 1, where the at least one criterion is comprised of a change in loading of at least one of the N carriers.

4. A method as in claim 1, where the at least one criterion is comprised of a change in radio conditions of at least one of the N carriers.

5. A method as in claim 1, where the at least one criterion is comprised of a change in a buffer state of a buffer associated with the mobile station.

6. A method as in claim 1, where the at least one criterion is comprised of a change in a buffer state of a packet data unit (PDU) buffer associated with the mobile station.

7. A method as in claim 1, where the operations of making an initial carrier allocation and subsequently re-allocating carriers occur in a Medium Access Control (MAC) layer that is coupled between an upper signaling layer and a lower Physical (PHY) layer.

8. A method as in claim 1, where the operations of making an initial carrier allocation and subsequently re-allocating carriers occur in a Physical layer coupled to a Medium Access Control (MAC) layer that is coupled to an upper signaling layer.

9. A method as in claim 1, where at least the operation of re-allocating carriers comprises sending a message to a Forward Packet Data Channel Control Function (FPDChCF) associated with a Forward Packet Data Control Channel (FPDCCH).

10. A method as in claim 1, where for a packet switched case at least the operation of re-allocating carriers comprises sending a message to a source Forward Packet Data Channel Control Function (FPDChCF) associated with a Forward Packet Data Control Channel (FPDCCH), and sending another message to a target FPDChCF associated with a target FPDCCH.

11. A method as in claim 1, where for a circuit switched case at least the operation of re-allocating carriers comprises sending a message to a Layer 3 (L3) function that responds by sending a further message through a forward dedicated signaling channel (f-dsch), or multiplexed in a fundamental forward dedicated traffic channel (f-dtch).

12. A multi-carrier (MC) wireless network, comprising a carrier selector function operable to make an initial carrier allocation of M carrier(s) to a mobile station, where M is less than or equal to a total number of carriers N in the MC wireless network; and further operable to re-allocate carriers to the mobile station, based on at least one criterion, by at least one of changing the value of M and moving the mobile station to at least one different carrier.

13. A MC wireless network as in claim 12, where the at least one criterion is comprised of a change in a quality of service (QoS) requirement of the mobile station.

14. A MC wireless network as in claim 12, where the at least one criterion is comprised of a change in loading of at least one of the N carriers.

15. A MC wireless network as in claim 12, where the at least one criterion is comprised of a change in radio conditions of at least one of the N carriers.

16. A MC wireless network as in claim 12, where the at least one criterion is comprised of a change in a buffer state of a buffer associated with the mobile station.

17. A MC wireless network as in claim 12, where the at least one criterion is comprised of a change in a buffer state of a packet data unit (PDU) buffer associated with the mobile station.

18. A MC wireless network as in claim 12, where said carrier selector comprises part of a Medium Access Control (MAC) layer that is coupled between an upper signaling layer and a lower Physical (PHY) layer.

19. A MC wireless network as in claim 12, where said carrier selector comprises part of a Physical layer coupled to a Medium Access Control (MAC) layer that is coupled to an upper signaling layer.

20. A MC wireless network as in claim 12, where said carrier selector is operable when re-allocating carriers to send a message to a Forward Packet Data Channel Control Function (FPDChCF) associated with a Forward Packet Data Control Channel (FPDCCH).

21. A MC wireless network as in claim 12, where for a packet switched case said carrier selector is operable when re-allocating carriers to send a message to a source Forward Packet Data Channel Control Function (FPDChCF) associated with a Forward Packet Data Control Channel (FPDCCH), and to send another message to a target FPDChCF associated with a target FPDCCH.

22. A MC wireless network as in claim 12, where for a circuit switched said case carrier selector is operable when re-allocating carriers to send a message to a Layer 3 (L3) function that responds by sending a further message through a forward dedicated signaling channel (f-dsch), or multiplexed in a fundamental forward dedicated traffic channel (f-dtch).

23. A mobile station operable in a multi-carrier (MC) wireless network and comprising a transceiver and a controller, said controller being responsive to a first message received from the MC wireless network via the transceiver to establish an initial carrier allocation of M carrier(s) for communication with the MC wireless network, where M is less than or equal to a total number of carriers N in the MC wireless network, said controller being further responsive to a subsequent message received during one of a circuit switched or a packet switched communication from the MC wireless network via the transceiver to re-allocate at least a number of carriers for communication with the MC wireless network.

24. A mobile station as in claim 23, where for the packet switched case said mobile station receives said subsequent message via at least one Forward Packet Data Channel Control Function (FPDChCF) associated with a Forward Packet Data Control Channel (FPDCCH).

25. A mobile station as in claim 23, where for the circuit switched case said mobile station receives said subsequent message through a forward dedicated signaling channel (f-dsch), or multiplexed in a fundamental forward dedicated traffic channel (f-dtch).

26. A computer program product embodied on a computer readable medium and comprising program instructions for directing at least one computer that comprises part of a multi-carrier (MC) wireless network to perform operations to allocate at least one carrier to a mobile station, the operations comprising:
making an initial carrier allocation of M carrier(s) to the mobile station, where M is less than or equal to a total number of carriers N in the MC wireless network; and
subsequently re-allocating carriers to the mobile station, based on at least one criterion, by at least one of changing the value of M and moving the mobile station to at least one different carrier.

27. A computer program product as in claim 26, where the at least one criterion is comprised of a change in at least one of a quality of service (QoS) requirement of the mobile station, loading of at least one of the N carriers, radio conditions of at least one of the N carriers, a buffer state of a buffer associated with the mobile station, a buffer state of a packet data unit (PDU) buffer associated with the mobile station.

28. A computer program product as in claim 26, where the operations of making an initial carrier allocation and subsequently re-allocating carriers occur in a Medium Access Control (MAC) layer that is coupled between an upper signaling layer and a lower Physical (PHY) layer.

29. A computer program product as in claim 26, where the operations of making an initial carrier allocation and subsequently re-allocating carriers occur in a Physical layer coupled to a Medium Access Control (MAC) layer that is coupled to an upper signaling layer.

30. A computer program product as in claim 26, where at least the operation of re-allocating carriers comprises sending a message to a Forward Packet Data Channel Control Function (FPDChCF) associated with a Forward Packet Data Control Channel (FPDCCH).

31. A computer program product as in claim 26, where for a packet switched case at least the operation of re-allocating carriers comprises sending a message to a source Forward Packet Data Channel Control Function (FPDChCF) associated with a Forward Packet Data Control Channel (FPDCCH), and sending another message to a target FPDChCF associated with a target FPDCCH.

32. A computer program product as in claim 26, where for a circuit switched case at least the operation of re-allocating carriers comprises sending a message to a Layer 3 (L3) function that responds by sending a further message through a forward dedicated signaling channel (f-dsch), or multiplexed in a fundamental forward dedicated traffic channel (f-dtch).

33. A computer program product embodied on a computer readable medium and comprising program instructions for directing at least one computer that comprises part of a mobile station to perform operations in a multi-carrier (MC) wireless network, the operations comprising, responsive to a first message received from the MC wireless network via a transceiver, establishing an initial carrier allocation of M carrier(s) for communication with the MC wireless network, where M is less than or equal to a total number of carriers N in the MC wireless network; and further responsive to a subsequent message received during one of a circuit switched or a packet switched communication from the MC wireless network via the transceiver, re-allocating at least a number of carriers for communication with the MC wireless network.

34. A multi-carrier (MC) wireless network, comprising means for initially selecting carriers to make a carrier allocation of M carrier(s) to a mobile station, where M is less than or equal to a total number of carriers N in the MC wireless network; and further comprising means, responsive to at least one criterion, for re-allocating carriers to the mobile station by at least one of changing the value of M and moving the mobile station to at least one different carrier.

35. A mobile station operable in a multi-carrier (MC) wireless network and comprising transceiver means and control means, said control means being responsive to a first message received from the MC wireless network via said transceiver means to establish an initial carrier allocation of M carrier(s) for communication with the MC wireless network, where M is less than or equal to a total number of carriers N in the MC wireless network, said control means being further responsive to a subsequent message received during one of a circuit switched or a packet switched communication from the MC wireless network via said transceiver means to re-allocate at least a number of carriers for communication with the MC wireless network.
